(19) United States
(12) Patent Application Publication
(10) Pub. No.: US 2021/0365960 A1
(43) Pub. Date: Nov. 25, 2021

(54) Social Network System

(71) Applicant: Selfiepay Holdings, Inc., Brooklyn, NY (US)

(72) Inventor: Sharron Battle, Las Vegas, NV (US)

(21) Appl. No.: 17/392,479

(22) Filed: Aug. 3, 2021

Related U.S. Application Data
(63) Continuation of application No. 16/733,396, filed on Jan. 3, 2020.
Application No. 16/733,396 is a continuation of application No. 12/829,601, filed on Jul. 2, 2010, now abandoned.
(60) Provisional application No. 61/222,594, filed on Jul. 2, 2009.

(51) Int. Cl. G06Q 30/02; G06Q 10/10

(52) U.S. Cl. CPC G06Q 30/02; G06Q 10/10

(57) ABSTRACT

Social networking systems use mobile communication devices or personal computers to manage business and social transactions from a single point of reference site. The social networking systems eliminate the need to access and log into multiple sites to carry out these tasks.

### CROSS REFERENCE TO RELATED APPLICATIONS

This application is a continuation of U.S. application Ser. No. 16/733,396, filed Jan. 3, 2020, which is a continuation of U.S. application Ser. No. 12/829,601, filed Jul. 2, 2010, which claims the benefit of U.S. Provisional Application Ser. No. 61/222,594, filed Jul. 2, 2009. The complete disclosures of all of the above patent applications are hereby incorporated by reference in their entirety for all purposes.

### SUMMARY OF THE INVENTION

In one aspect of the present invention, an internet website provides a single point member-user access to a multiplicity of websites and functions, the website comprises a single login function that connects the member-user to a community landing point, said landing point providing point and click access to other internet websites; a community information posting and retrieving site; an individual information posting and retrieval site; and intermember communication capability.

In another aspect of the present invention, a method for social networking comprises providing a member-user with a single login function to connect the member-user to a community landing point; providing the member-user with a community information posting and retrieving site for searching for a job, submitting a proposal, sharing knowledge, searching for user created content and searching for statistics and performance of users within a social network; providing the member-user with an individual information posting and retrieval site; and providing the member user with intermember communication capability.

These and other features, aspects and advantages of the present invention will become better understood with reference to the following drawings, description and claims.

### BRIEF DESCRIPTION OF THE DRAWINGS

FIGS. 1 A and 1 B are connecting flow charts showing a method of social networking through mobile interactivity on a global basis, according to an embodiment of the present invention; and

FIGS. 2A and 2B are connecting flow charts and, along with FIGS. 2C and 2D, are a series of flow charts showing a method of social networking through profile interactivity on a global basis, according to an embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features.

Broadly, an embodiment of the present invention provides social networking systems using mobile communication devices or personal computers to manage business and social transactions from a single point of reference site. The social networking systems of the present invention may eliminate the need to access and log into multiple sites to carry out these tasks.

Embodiments of the present invention comprise an application of the method of the invention using mobile technology to access the site; another application for use of personal computer technology, and another application to carry out multiple transactions from a single individual profile page at the reference site.

The method of the invention operates through a website that accommodates what can be termed “Lean Social Exchange.”

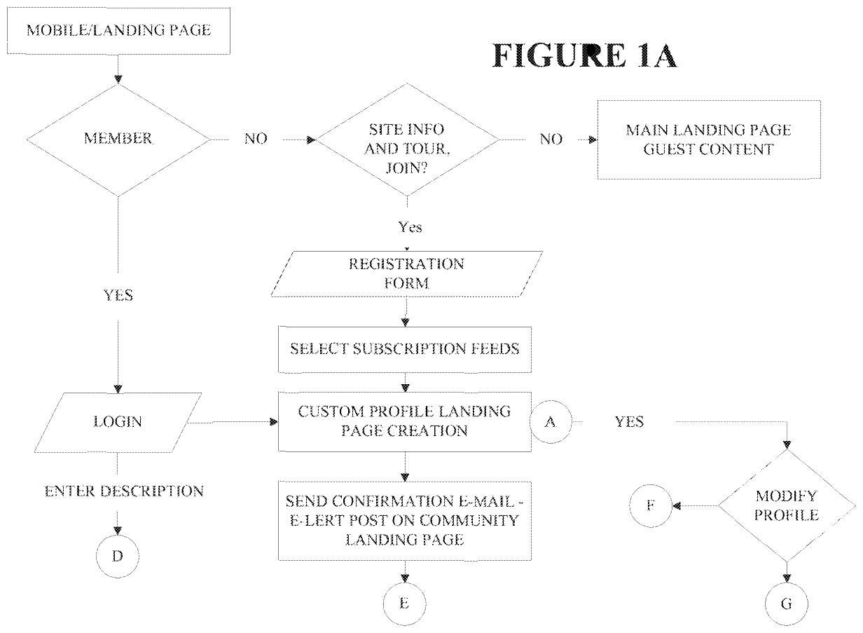

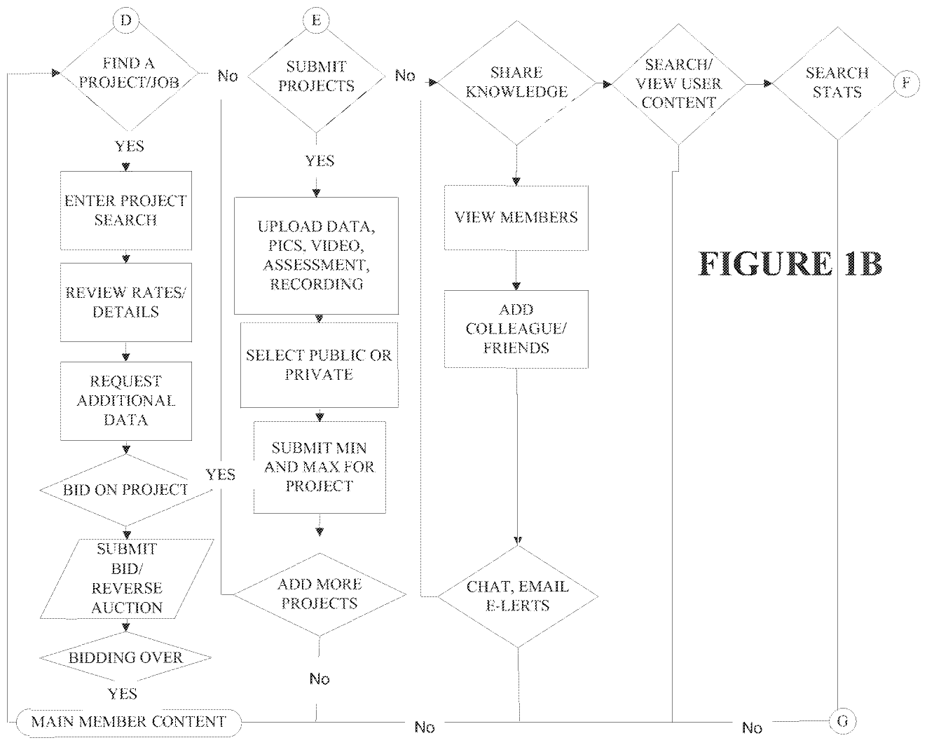

The application for use of a mobile device, which can be a cell phone or personal data assistant (PDA), or a personal computer is shown in the flowchart of FIGS. 1 A and 1 B. Using either means of access, the user arrives at the Loreshare.com URL and a mobile landing page, and a decision point to determine membership. If not a member, the user can view the site information, take a site tour, read through the landing site page content, and, if desired, join the site by filling out a registration form. An email confirmation may then be sent to the newly joined member and an e-lert may be posted on the individual community-landing page.

If the user joins the site, he can then select subscription feed to be directed to his profile. He can also customize his profile page as well as his individual community-landing page.

At the personal profile page, the following can be done: taking personality assessments, download virtual book publications, upload and take tests, download online games, recordings, pictures, videos, virtual files and data, sms, receive messages from PCs or mobile devices, obtain a filtered list of mobile news, geo location awareness, advertisements, virtual tools, obtain mentors and tutors, internal virtual content search capability and access the community landing page.

The community landing page may be a person's individual community page where all the colleagues and friends he has accepted in his profile have access. The community landing page may have geo location capability, news, and listings of recent jobs, advertisements, user generated content, news channeling and the like.

If the user is already a member of the site, he will log in and go directly to the individual community-landing page and then to his individual profile homepage. The profile has the capability of being put to business or leisure mode as set up by the user.

Once a user is a member of the site, he can select an activity in which he seeks to find a project or job, he can submit a project for consideration, or he can share knowledge and virtual goods.

He can search for potential jobs or projects by entering the project or search criteria, then review the rates and project details, request additional data, and then bid on the offer. He can also review any project or job offering details, and have the opportunity to bid on a project, or if suitable, participate in a reverse auction.

The user can also submit his own projects or job offer by selecting “submit project or job” where he can upload any relevant information supporting the project or job requirements using site technology, including incorporating a data storage file, pictures, video clips, assessments, recordings and other relevant information. He can also select minimum and maximum values for the purposes of auction and indicate whether the project is private or public. By going back to the main member site and repeating the “submit project or job” option, the user can list a second project or job.

If the user is visiting the site to share knowledge, he can view other member's information, add colleagues or friends to his profile, email, chat or send ealerts.

The contents of the personal profile may have testing (“LoreTag”) assessments, online virtual publication downloads, online game downloads, recordings, pictures, videos, virtual files and data, geo location awareness, news streaming, use of virtual tools, and access to individual community landing pages for the communities the individual user develops with colleagues and friends.

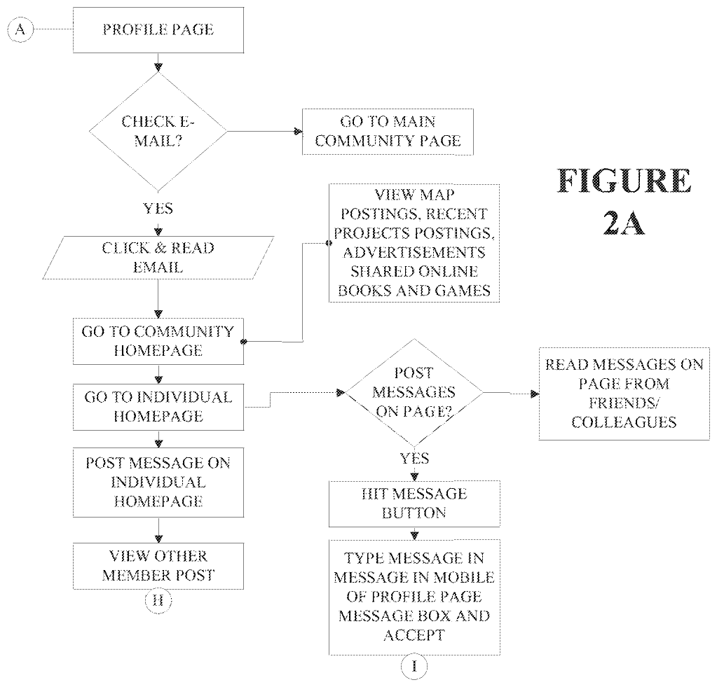

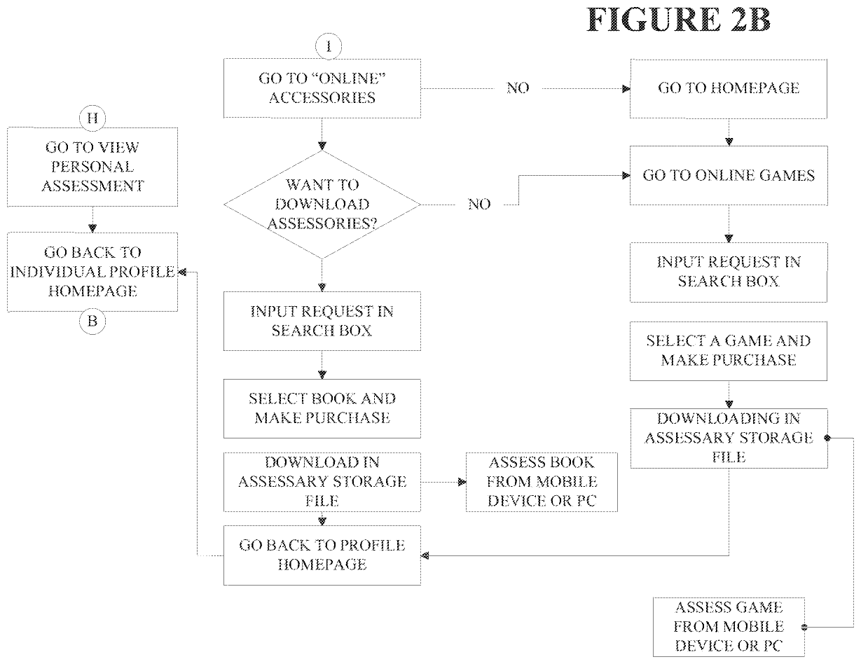

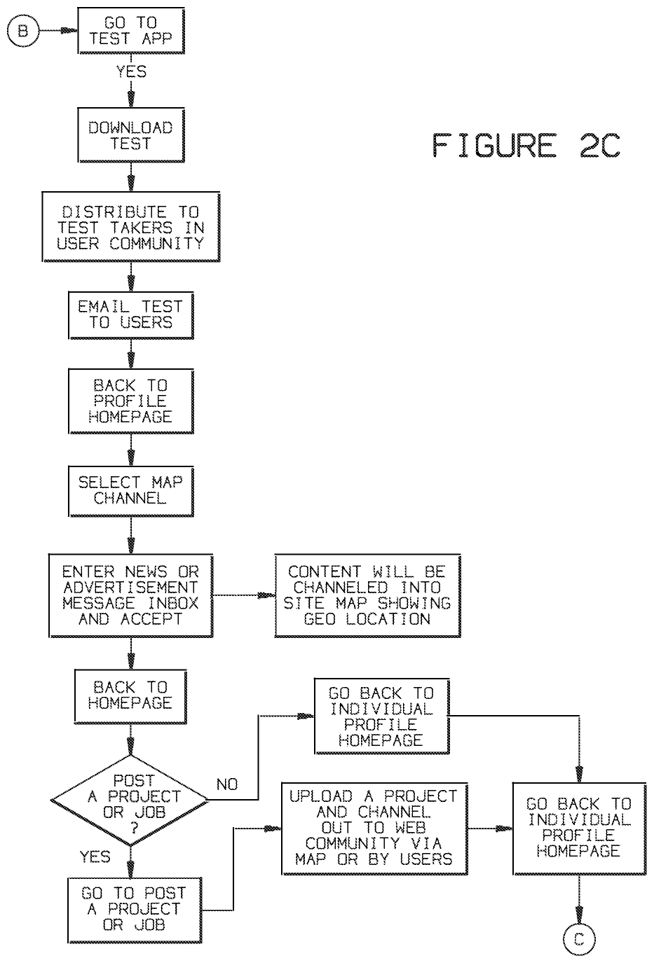

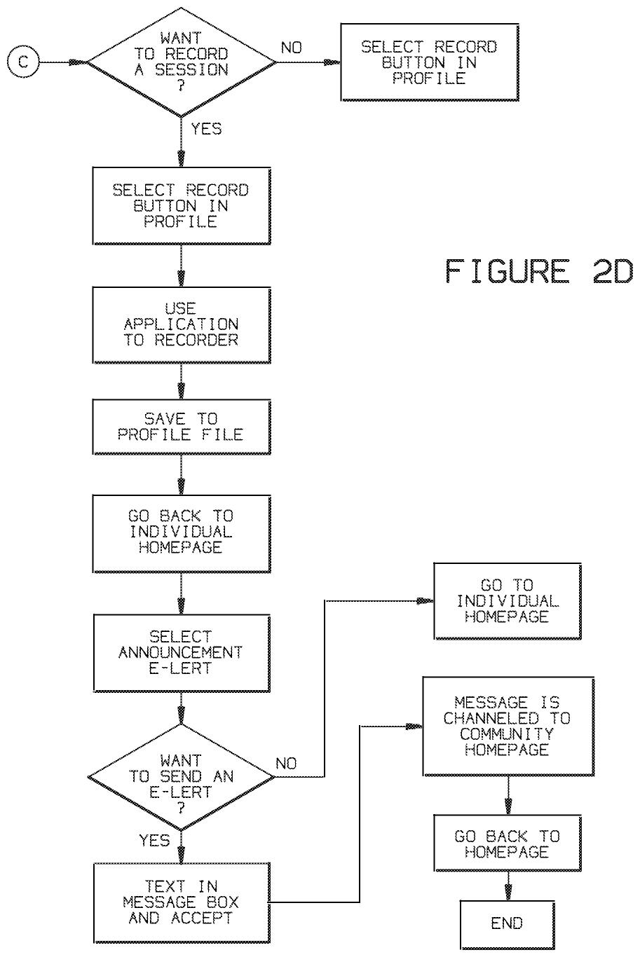

The flowcharts of FIGS. 2A, 2B, 2C and 2D show the steps for profile interactivity global. When using the system for this purpose, (FIGS. 2A and 2B), the user may log in as indicated and may have the opportunity to check and read his email before going to the community homepage, where he can view postings, advertisements, and online virtual publications and games and the like. He can then go to his individual profile homepage where he can post messages or view messages others have posted there. The user can go to view his personal assessment and then go back to his individual profile homepage. Messages are posted on the profile by hitting the message button, typing the message in the mobile of the profile page message box and hitting “accept.”

At this point he can go to online accessories to download virtual publications or games. He can input a request for a publication or game search in the research box, and purchase and download an accessory. He then goes back to the profile homepage. Alternatively, instead of going to online accessories, he can go to homepage to request a game, for example. He inputs his request in the search box, selects a game and makes a purchase, then downloads the game in an accessory storage file, from where he can access the game using his mobile device or PC.

In an alternative interactive profile use shown in FIG. 2C, the user can go from his individual profile page (FIG. 1 A, point A) to a testing application site (FIG. 2C, point B) from where he can download a test through a mobile device or PC. He may then distribute the test to test-takers in the user community, perhaps by email. At this point, he has the option to go back to the profile homepage and select, for example, the map channel. Here he can access the news or advertisement message inbox and accept. The content will be channeled into the site map showing a geo location. He can now go back to the homepage, post a job or project, or if not, go to his individual profile page to arrive at point C in FIG. 2C.

From point C, the user can go on, as shown in FIG. 2D, to a site to record a session by selecting the record button in his profile (FIG. 2D, point C). The application may be used to record to the site profile from a PC or mobile device. He can save the recording to profile. If the user chooses not to record a session, he can go back to the individual homepage immediately. The user can now select an announcement e-alert from the profile, text in a message in the message box and accept. The message is then channeled to the community homepage, and the user can go back to the homepage. Any of these tasks can be done from any mobile device or a personal computer.

By using one point of reference login capability to one site rather than multiple sites, the system can gather together privatized video use and global information sharing for business real-time, profile use and testing and upload, file exchange, personality assessment and personal development, statistical job performance rating, job interviewing via video together with storing on the profile, submitting a project and bidding for a job. It can add multiple jobs or projects to the site and allow access to jobs globally from a mobile device. Members can participate in reverse auctions real-time from their mobile device and accept jobs and submit jobs back to the outsourcer and get paid in ecommerce.

The method of the invention can direct the profile to business or leisure mode for viewing of members. It can channel news from the profile to a mobile device and a geo location capability from the profile to a mobile device, and upload files to the profile while providing access from the mobile device. It can connect applications to the profile, either to store or use. Chats, emails, videos, files and real-time e-lerts will be able to be channeled back and forth from mobile devices to PCs.

The method may also provide member interactivity. Members may be able to collaborate with other users in either business or leisure mode while what is being viewed on the profile page is protected from what is being viewed on profiles by other users in the social networking community. Members will be able to view other members in their community as well as search for other members for job tasks or mentorship. Ealerts and some messages may be filtered to the site map with a GPS identifier.

It is contemplated that the user will select advertisements on profiles, and advertiser banners will be rated for the most hits. Members of the site will have the ability to create advertisements from a PC or mobile device and may be filtered into the site map or individual community-landing page of the individual.

The site may allow users to use one password login instead of several. A registration form may be submitted to ensure that other users are protected and the necessary information is collected to ensure protection of integrity of job biddings, ratings of user performance and uploads of job or project listings. The computer may help execute the functions provided on the social network. A mobile device may provide full access and participation in the process designed for Internet users.

The one-point information sharing system and methods of the invention may solve the problem of internet users having to access multiple sites to accomplish simple tasks such as professional/friend connections, collaborations, use of virtual tools and goods, job searches and leisure networking. It may improve the efficiency of job searches. The site may open new doors for collaboration and personal development and still offer leisure activities.

It should be understood, of course, that the foregoing relates to exemplary embodiments of the invention and that modifications may be made without departing from the spirit and scope of the invention as set forth in the following claims.

1. (canceled)

2. A social network application stored on a non-transitory computer readable storage medium that provides a single point access to multiple profiles, comprising:
a single login function configured to connect a device of a particular user to a member account of the social network that includes at least two different profiles for the particular user, wherein connection to the member account enables the particular user to view, in a single profile page, information posted to both of (i) a first profile from among the at least two different profiles of the particular user and (ii) a second profile from among the at least two different profiles of the particular user; and
a mode selection function, within the member account, configured to receive a user selection of one of the at least two different profiles, and switch between the at least two different profiles based on the received user selection while the particular user remains connected to the member account by way of the single login function, wherein:
user selection of the first profile from among the at least two different profiles enables the particular user to collaborate with other users of the social network application using the first profile, while protecting information in the second profile from the other users, and while providing the particular user with access to the information in the second profile; and
user selection of the second profile enables the particular user to collaborate with other users of the social network application using the second profile, while protecting information in the first profile from the other users, and while providing the particular user access to the information in the first profile.

3. The social network application of claim 2, further comprising:
a community page of the member account that is accessible to (i) business connections associated with the first profile and (ii) personal connections associated with the second profile.

4. The social network application of claim 3, wherein the particular user is enabled to navigate, within the account, between the community page and a profile page for each of the first profile and the second profile.

5. The social network application of claim 4, wherein the connection to the member account enables the particular user to post information to each of the first profile and the second profile, wherein information posted to the first profile is viewable to the other users the particular user collaborates while when the first profile is selected using the mode selection function, and wherein information posted to the second profile is viewable to the other users the particular user collaborates with when the first profile is selected using the mode selection function.

6. The social network application of claim 2, further comprising a jobs database that enables the particular user to search for a job, submit a project for consideration, request additional data on the job, and bid on the job.

7. The social network application of claim 2, further comprising a link to a testing application site including tests the particular user is able to download and distribute to other users.

8. The social network application of claim 2, wherein the social network application is accessible by a mobile device or a personal computer.

9. The social network application of claim 2, further comprising intermember communication capability on one of a community information posting and retrieving site or an individual information posting and retrieval site, wherein at least one of the community information posting and retrieving site or the individual information posting and retrieval site includes messages that are filtered based on a geographic positioning system identifier.

10. The social network application of claim 2, wherein the first profile provides selective access to individual pages of other users, a searching function for statistics and performance of the other users, and selective geo location awareness of content and the other users.

11. The social network application of claim 2, wherein content posted to either of the first profile or the second profile comprises at least one of news, files, applications, chats, emails, videos, or real-time e-lerts.

12. The social network application of claim 2, wherein both the first profile and the second profile are configured to provide a collaborative data-sharing connection between the particular user and a second user while at least some information that is displayed to the particular user on a profile page is protected from being viewed by the second user.

13. The social network application of claim 2, wherein messages on a community page are filtered based on a global positioning system identifier.

14. The social network application of claim 2, wherein the user selection of the first profile using the mode selection function provides a request function configured to enable the particular user to post a proposal to a list of colleagues added by the particular user via the single profile page.

15. The social network application of claim 14, wherein the list of colleagues includes at least a third user that is not included in a list of friends that are able to view the second profile.

16. The social network application of claim 2, wherein user selection of the second profile using the mode selection function provides a feedback function configured to enable the particular user to provide feedback in response to a proposal posted by a different user.

17. A method, comprising:
connecting, by a single login function of a social network application executing on one or more computers, a device of a particular user to a member account of the social network that includes at least two different profiles for the particular user, wherein connection to the member account enables the particular user to view, in a single profile page, information posted to both of (i) a first profile from among the at least two different profiles of the particular user and (ii) a second profile from among the at least two different profiles of the particular user;
receiving, within the member account and by a mode selection function of the social network application, a user selection of one of the at least two different profiles, and switch between the at least two different profiles based on the received user selection while the particular user remains connected to the member account by way of the single login function, wherein:
user selection of the first profile from among the at least two different profiles enables the particular user to collaborate with other users of the social network application using the first profile, while protecting information in the second profile from the other users, and while providing the particular user with access to the information in the second profile; and
user selection of the second profile enables the particular user to collaborate with other users of the social network application using the second profile, while protecting information in the first profile from the other users, and while providing the particular user access to the information in the first profile.

18. The method of claim 17, further comprising providing, within the social network application, a community page of the member account that is accessible to (i) business connections associated with the first profile and (ii) personal connections associated with the second profile.

19. The method of claim 18, further comprising enabling the particular user to navigate, within the account, between the community page and a profile page for each of the first profile and the second profile.

20. The method of claim 19, further comprising enabling the particular user to post information to each of the first profile and the second profile, wherein information posted to the first profile is viewable to the other users the particular user collaborates while when the first profile is selected using the mode selection function, and wherein information posted to the second profile is viewable to the other users the particular user collaborates with when the first profile is selected using the mode selection function.

21. The method of claim 17, further comprising providing access to a jobs database that enables the particular user to search for a job, submit a project for consideration, request additional data on the job, and bid on the job.
